(19) United States
(12) Patent Application Publication
(10) Pub. No.: US 2023/0177961 A1
(43) Pub. Date: Jun. 8, 2023

(54) METHOD OF PROVIDING ASSISTANCE TO DRIVER BASED ON HIGH-DEFINITION MAP OF ROAD, AND VEHICLE INTERCOMMUNICATION SYSTEM APPLYING METHOD

(71) Applicant: Mobile Drive Netherlands B.V., Amsterdam (NL)

(72) Inventor: JING-LONG YANG, New Taipei (TW)

(21) Appl. No.: 18/073,840

(22) Filed: Dec. 2, 2022

(30) Foreign Application Priority Data
Dec. 3, 2021 (CN) 202111467190.4

(51) Int. Cl. G08G 1/16; B60R 1/00; B60W 30/095; G08G 1/01; G05D 1/02

(52) U.S. Cl. CPC G08G 1/162; G08G 1/166; B60R 1/005; B60W 30/0956; G08G 1/0112; G08G 1/0141; G08G 1/0125; G08G 1/012; G05D 1/0214

(57) ABSTRACT

A method providing driving assistance based on a high-definition road map acquires information such as real time position of a vehicle, real time driving speed, and real-time information of upcoming road intersections. The intersection information includes traffic light information. Determinations as to whether the vehicle can safely pass through the intersection based on the real-time driving speed, and distances to and across the intersection are made, and it is also determined whether safe passage through the intersection is possible. An information intercommunication platform generates warnings to the vehicle being driven and other relevant when a crash is deemed likely between two vehicles, based on the determinations from the relevant vehicles which are in a specified range. A vehicle intercommunication system applying the method is also disclosed.

### FIELD

The subject matter herein generally relates to traffic safety.

### BACKGROUND

Cars are ever more widespread and traffic safety becomes more important. While negotiating traffic lights, drivers always estimate whether there is an enough time for passing through by driving experience. An incorrect evaluation by the drivers may be catastrophic. Communications between vehicles and communications between vehicles and traffic light terminals are commonplace. Images of the traffic light at an intersection in front of a vehicle can be captured by a camera in the vehicle. However, prompt information based on traffic light and locations of other vehicles in the captured images is usually not provided. Lack of such information which may affect the safe driving of the vehicle.

Thus, there is room for improvement in the art.

### BRIEF DESCRIPTION OF THE FIGURES

Implementations of the present disclosure will now be described, by way of example only, with reference to the attached figures.

FIG. 1 is a diagram illustrating an embodiment of a vehicle intercommunication system; the intercommunication system comprises an information intercommunication platform and a vehicle with a driving assistance system according to the present disclosure.

FIG. 2 is a diagram illustrating an embodiment of the driving assistance system of FIG. 1 according to the present disclosure.

FIG. 3 is a diagram illustrating an embodiment of the information intercommunication platform of FIG. 1 according to the present disclosure.

FIG. 4 is a diagram illustrating an embodiment of an application environment of the of FIG. 1 according to the present disclosure.

FIG. 5 is a flowchart illustrating an embodiment of a method of driving assistance according to the present disclosure.

FIG. 6 is a detailed flowchart illustrating an embodiment of block 12 in the flowchart in FIG. 5 according to the present disclosure.

FIG. 7 is a detailed flowchart illustrating an embodiment of block 13 in the flowchart in FIG. 5 according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM, magnetic, or optical drives. It will be appreciated that modules may comprise connected logic units, such as gates and flip-flops, and may comprise programmable units, such as programmable gate arrays or processors, such as a CPU. The modules described herein may be implemented as either software and/or hardware modules and may be stored in any type of computer-readable medium or other computer storage systems. The term “comprising” means “including, but not necessarily limited to”; it specifically indicates open-ended inclusion or membership in a so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

The present disclosure provides a method for providing assistance to driver based on a high-definition (HD) map, and a vehicle intercommunication system applying the method.

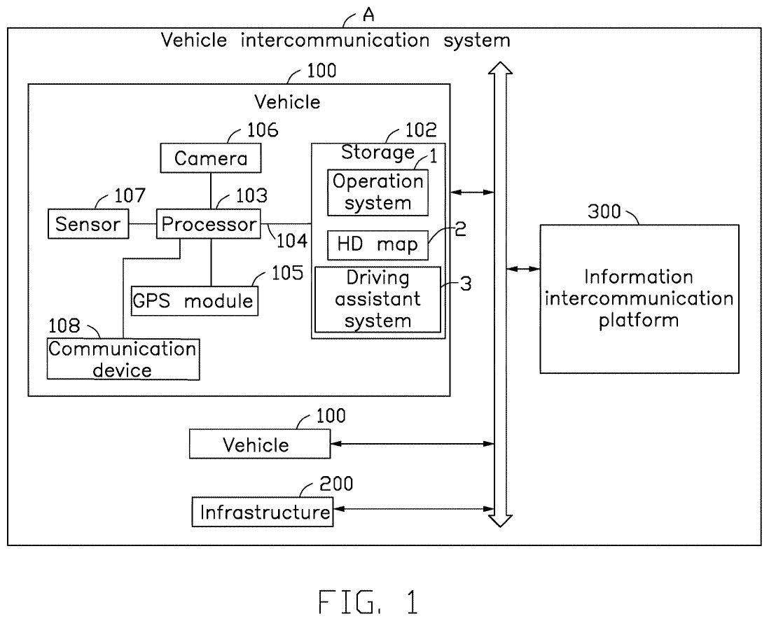

FIG. 1 shows a vehicle intercommunication system A. The vehicle intercommunication system A includes several vehicles 100, at least one infrastructure 200, and information intercommunication platform 300. The vehicles 100 and the at least one infrastructure 200 communicate with the information intercommunication platform 300 for exchanging data through a wireless communication network, such as a mobile communication network or a satellite network. In one embodiment, the infrastructure 200 can be a communication infrastructure, a traffic infrastructure, and other type of infrastructure. The communication infrastructure can be a communication base station, a mobile communication device, not being limited. The traffic infrastructure can be a traffic light, traffic signs, not being limited thereto. The information intercommunication platform 300 can be a server or a terminal device, not being limited thereto.

Each vehicle 100 includes a storage 102, a processor 103, a data bus 104, a global positioning system (GPS) module 105, a camera 106, at least one sensor 107, and a communication device 108.

The vehicle 100 acquires a real-time location and speed of itself, and a real-time information through the GPS module 105, and acquires an intersection information in front of the vehicle 100, for passing through the intersection. The communication device 108 is based on the real-time position of the vehicle 100, and determines whether the vehicle 100 can safely pass through an intersection without being crashed with other vehicles based on the real-time driving speed and the intersection information. The vehicle 100 can prompt and/or control the vehicle 100, and output a result of determination to the information intercommunication platform 300. The vehicle 100 also can receive warning information as a warning of a likely crash between the vehicle 100 and other vehicles in a predefined region R from the information intercommunication platform 300.

The storage 102 stores program codes. The storage 102 can be an embedded circuit having a storing function, such as a memory card, a trans-flash (TF) card, a smart media card, a secure digital card, and a flash card, and so on. The storage 102 transmits data with the processor 103 through the data bus 104. The storage 102 stores an operation system 1, an HD map 2, and a driving assistance system 3.

The operation system 1 manages and controls hardware and software programs. The operation system 1 further supports operations of the driving assistance system 3 and other software and programs.

The HD map 2 includes lane information, lane symbols, intersection information, a speed limit information, and so on. In at least one embodiment, the lane information includes information such as possible left turn, right turn, and straight-on direction, not being limited hereto. The lane information is specific for confirming a traffic light governing the lane information of the vehicle 100, in which the vehicle 100 is driving. For example, when the lane information of the vehicle 100 is a left turn lane, the portrayed color of the traffic light corresponding to the left turn lane is acquired. The lane symbols indicate a type of each lane. In one embodiment, the lane symbols can be a left turn arrow, a combined left turn and straight-on arrow, an arrow for a straight-on only lane, and a right turn arrow, not being limited hereto. In at least one embodiment, the intersection information can include an intersection distance of the vehicle 100 from the real-time position to pass through the acquired intersection, a traffic light color-change function, and a traffic light information. The intersection distance of the vehicle 100 can include a first distance and a second distance. The first distance is a distance between the real-time position and the acquired intersection, and the second distance is a width of the acquired intersection. The traffic light color-change function stores a table, which records a relationship between colors of the traffic light and switching times. The traffic light information can include real-time color of the traffic light. The intersection generally displays three traffic lights. The color of each traffic light can change between three predefined colors. The color of each traffic light switches in a predefined sequence. The colors of each traffic light include red, green, and yellow (amber). The predefined sequence is green to yellow to red to green. The switching time is a time duration from the current display of the color to the display of the next color. For example, when the current display of the color is green, the switching time is a time duration from the current display of the green light until switching to the yellow light. In other embodiment, the traffic light color-change function can be achieved from the information intercommunication platform 300. The speed limit information can include speed limit symbols and removal speed limit symbols.

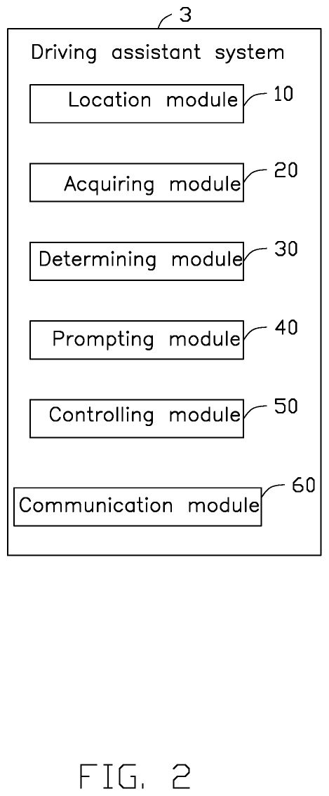

The processor 103 can be a micro-processor or a digital processor. The processor 103 is used for running the program codes stored in the storage 102 to execute different functions. Modules in FIG. 2 are program codes stored in the storage 102 and are implemented by the processor 103 for executing a method for driving assistance based on the HD map 2. The processor 103 can be a central processing unit

(CPU), or a large scale integrated circuit, being an operating core and a control core.

The data bus 104 exchanges data with the storage 102 and the processor 103.

The GPS module 105 locates the real-time position of the vehicle 100 (such as longitude and latitude information) and the real-time information.

The camera 106 can capture still images or record video while driving. In at least one embodiment, the camera 106 can be set inside or beside the vehicle 100. For example, the cameral 106 can be the data recorder inside the vehicle 100 or a camera on a front rearview mirror outside the vehicle 100. When the camera 106 is outside the vehicle 100, the processor 103 can control the camera 106 to rotate for obtaining the traffic information.

The at least one sensor 107 can detect a distance between the vehicle 100 and other vehicles. In at least one embodiment, the at least one sensor 107 can include a radar sensor, a speed sensor, and an acceleration sensor, not being limited hereto.

The communication device 108 can communicate with the information intercommunication platform 300 for transmitting the result of determination and receiving the warning information or a safety prompting information.

FIG. 2 shows the driving assistance system 3. The driving assistance system 3 includes a plurality of modules.

A location module 10 acquires driving characteristics of the vehicle 100.

In at least one embodiment, the driving characteristics can include the real-time position information of the vehicle 100, the real-time driving speed of the vehicle 100, and real-time information. The location module 10 acquires the real-time position information and the real-time through the GPS module 105, and calculates the real-time driving speed based on the real-time position information and the real-time information.

In one embodiment, there are at least two real-time positions and two real-time points corresponding to the two real-time positions. A moved distance is calculated based on the two real-time positions, and a time interval is calculated based on the two time points, and the real-time driving speed is calculated based on the moved distance and the time interval. In other embodiments, the real-time driving speed can also be sensed by the at least one sensor 107 on the wheel of the vehicle 100 or by a speed sensor in the vehicle 100.

An acquiring module 20 acquires the intersection information in front of the real-time position information of the vehicle 100 based on the driving characteristics, which indicates the distance of the vehicle 100 to pass through the intersection, and the traffic light color-change function.

In at least one embodiment, the intersection information includes an intersection distance of the vehicle 100 from the real-time position to pass through the intersection.

The acquiring module 20 further calculates the intersection distance of the vehicle 100 through the HD map 2 or the camera 106. The intersection distance of the vehicle 100 includes a first distance and a second distance. The first distance is from the real-time position of the vehicle 100 to the intersection, and the second distance is a width of the intersection. In at least one embodiment, the first distance and the second distance are obtained through the HD map 2. In another embodiment, one of the first distance and the second distance can be obtained through the HD map 2, and the other of the first distance and the second distance can be obtained through the camera 106. In another embodiment, both the first distance and the second distance are obtained by the camera 106.

A determining module 30 determines whether the intersection distance is less than a predefined distance.

If the intersection distance is less than the predefined distance, the acquiring module 20 further acquires the traffic light information.

In at least one embodiment, the traffic light information can include a color information of the traffic light. The intersection generally displays three traffic light, as described previously.

The determining module 30 further determines whether the vehicle 100 can safely pass through the intersection based on the real-time driving speed and the intersection information.

The acquiring module 20 further acquires a first time information corresponding to the color of the traffic light switching from green to yellow by the traffic intercommunication platform 300, and acquires the real-time position information of the vehicle 100 corresponding to the first time information through the location module 10, acquires the intersection distance based on the real-time position information of the vehicle 100 corresponding to the first time information, acquires a first reference time duration based on the intersection distance of the vehicle 100 and the real-time driving speed of the vehicle 100, and acquires a second reference time duration based on the first time information and the traffic light color-change function.

The determination module 30 further determines whether the first reference time duration is greater than the second reference time duration. When the first reference time duration is greater than the second reference time duration, it determines that the vehicle 100 cannot safely pass through the intersection. When the first reference time duration is shorter than or equal to the second reference time duration, it determines that the vehicle 100 can safely pass the intersection.

In at least one embodiment, the second reference time duration is a switching time duration for switching the current color of the corresponding traffic light to next color. For example, when the time of switching the color of the corresponding traffic light switches from green to yellow at 10:23:00, the first time information acquired by the acquiring module 10 is 10:23:00. The real-time position information of the vehicle 100 is acquired by the location module 10 based on the first time information. The intersection distance is acquired from on the HD map 2 based on the real-time position information. The intersection distance includes the first distance and the second distance. The first distance is a distance from the real-time position to the intersection, and the second distance is a width across the intersection. The first reference time duration is 10 seconds based on the intersection distance and the real-time driving speed of the vehicle 100. The second reference time duration of switching the color of the corresponding traffic light from yellow to red is 5 seconds based the traffic light color-change function. The first reference time duration is greater than the second reference time duration, thus it is determined that the vehicle 100 cannot safely pass through the intersection.

In another embodiment, when the color of the corresponding traffic light switches from green to yellow at 12:10:00, the first time information is 12:10:00. The real-time position information of the vehicle 100 is acquired by the location module 10 based on the first time information. The intersection distance is acquired from on the HD map 2 based on the real-time position information. The intersection distance includes the first distance and the second distance. The first distance is a distance from the real-time position information to the intersection, and the second distance is a width across the intersection. The first reference time duration is 3 seconds based on the intersection distance and the real-time driving speed of the vehicle 100. The second reference time duration of switching the color of the corresponding traffic light from yellow to red is 5 seconds based the traffic light color-change function. The first reference time duration is shorter than the second reference time duration, thus it is determined that the vehicle 100 can safely pass through the intersection.

A prompting module 40 generates a prompt to a driver when it is determined that the vehicle 100 cannot safely pass through the intersection. In at least one embodiment, the prompt can be a voice prompt, an image prompt, a loud whistled prompt, not being limited hereto.

A controlling module 50 generates a control event when it is determined that the vehicle 100 cannot safely pass through the intersection. In at least one embodiment, the control event can be a slow-down instruction, a stop instruction, a whistled instruction, not being limited hereto.

A communication module 60 transmits a result of the determination. The communication module 60 further receives warning information from the information intercommunication platform 300 when a crash at the intersection between the vehicle 100 and other vehicles in a predefined range R is likely.

In at least one embodiment, the result of determination includes whether the vehicle 100 can safely pass through the intersection and an expected time of passing through the intersection.

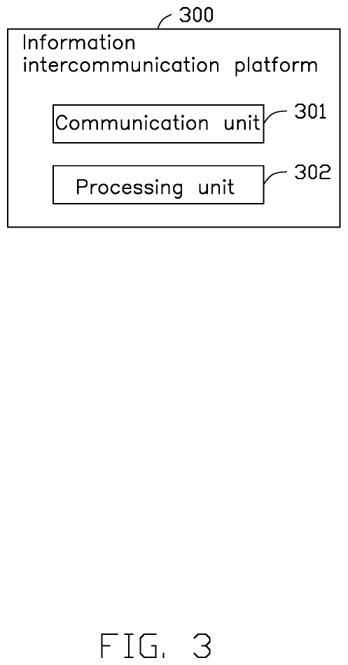

FIG. 3 shows the information intercommunication platform 300. The information intercommunication platform 300 determines whether a crash at the intersection between each two vehicles 100 in the predefined range R is likely based on the received results of determination from the different vehicles 100.

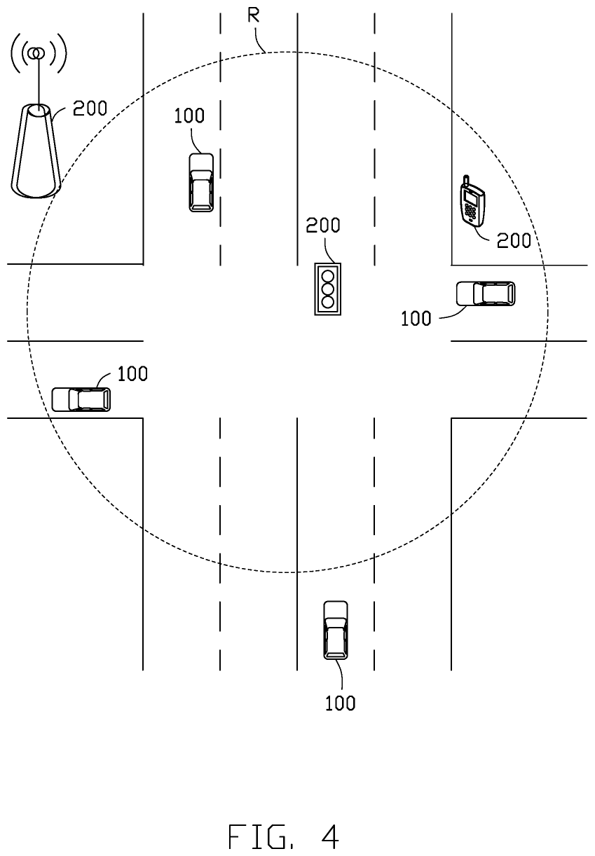

In at least one embodiment, the information intercommunication platform 300 includes a communication unit 301 and a processing unit 302. The communication unit 301 communicates with the vehicles 100 and the infrastructure 200. The information intercommunication platform 300 receives the results of determination from several vehicles 100 in the predefined region R based on the real-time position information, and the traffic light color-change function from the infrastructure 200. The information intercommunication platform 300 acquires the results of the determination from the different vehicles 100 in the predefined region R of the intersection acquired by the vehicle 100. In at least one embodiment, as shown in FIG. 4, the predefined range R is a circular region with a center on the center of the intersection, and a diameter of the predefined range R is a predefined value. In other embodiments, the predefined range R can be other shape, such as a rectangular, or a T shape, not being limited hereto.

The processing unit 302 determines whether a crash is likely at the intersection between each two vehicles 100 in the predefined region R based on the results of determination. When a crash is likely at the intersection between the two vehicles 100 in the predefined region R based on the results of determination, the processing unit 302 generates the warning information to the corresponding vehicles 100 through the communication unit 301.

In at least one embodiment, when the results of determination from different vehicles 100 are the vehicles 100 can safely pass through the same intersection, the processing unit 302 determines whether the expected times are almost the same. In at least one embodiment, the processing unit 302 determines whether a time difference of each two expected times is less than a predefined threshold value (that is, the same or almost the same), for determining whether the expected times are close. When the time difference of two expected times is less than the predefined threshold value, a crash is deemed likely at the intersection between the two vehicles 100 corresponding to the expected times by the processing unit 302, and the warning information is generated. When the time difference of two expected times is larger than or equal to the predefined threshold value (that is, not almost the same), a crash is deemed unlikely at the intersection between the two vehicles 100 corresponding to the expected times by be processing unit 302.

Based on the vehicle intercommunication system A and the HD map 2, the driving characteristics and intersection information are acquired, and whether the vehicle 100 can safely pass through the intersection is determined. A result of determination is transmitted to the information intercommunication platform 300, and the information intercommunication platform 300 determines whether the crash at the intersection between each two vehicles 100 in the predefined region R is likely. If likely, a warning information is generated to the corresponding vehicles 100 when the crash is likely at the intersection. Precise driving assistance is provided, safety while driving the vehicle 100 is improved, and a smart control of the vehicle 100 is optimized.

In at least one embodiment, a method for driving assistance is used in the driving assistance system 3 of the vehicle intercommunication system A of a vehicle.

The vehicle intercommunication system A can include a part or more hardware or software in FIGS. 1-3, or the elements in different locations. The vehicle intercommunication system A provides a visible interface. The visible interface provides an interface for user to communicate with the vehicle intercommunication system A. The vehicle intercommunication system A communicates with at least two vehicles 100 and the infrastructure 200 to implement the method.

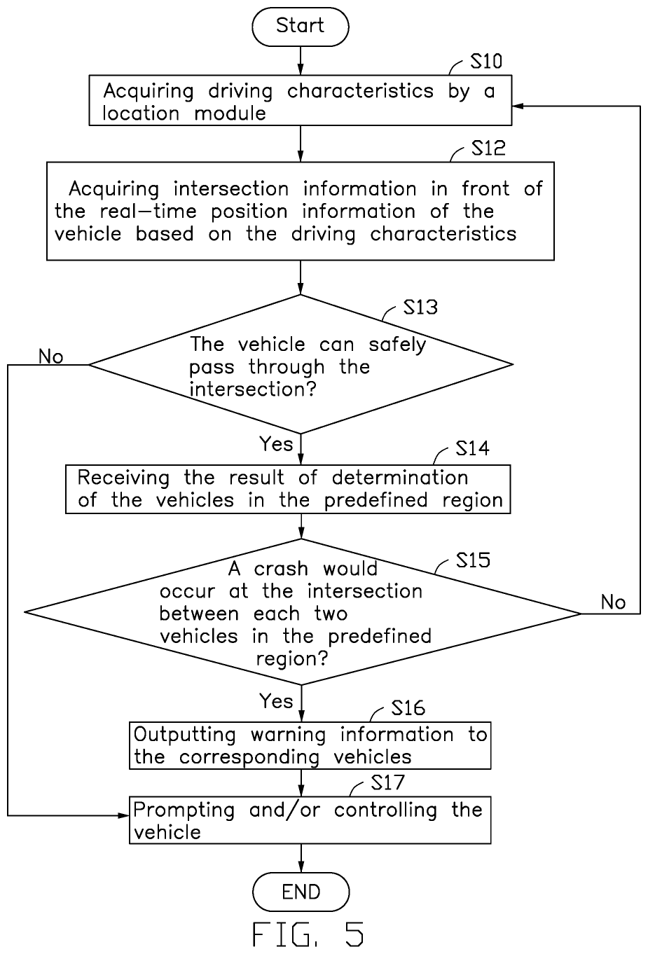

FIG. 5 shows a flowchart of a method for the above. The method may comprise at least the following steps, which also may be re-ordered:

In block 10, the location module 10 acquires driving characteristics.

In at least one embodiment, the driving characteristics can include real-time position information of the vehicle 100, the real-time driving speed of the vehicle 100, and real-time information. The location module 10 acquires the driving characteristics through the GPS module 105.

In at least one embodiment, the driving characteristics can include the real-time position information of the vehicle 100, the real-time driving speed of the vehicle 100, and real-time information of the vehicle 100. The location module 10 acquires the real-time position information and the real-time through the GPS module 105, and calculates the real-time driving speed based on the real-time position information and the real-time information.

In one embodiment, there are at least two real-time positions and two real-time points corresponding to the two real-time positions. A moved distance is calculated based on the two real-time positions, and a time interval is calculated based on the two time points, and the real-time driving speed is calculated based on the moved distance and the time interval. In other embodiments, the real-time driving speed can also be sensed by the at least one sensor 107 on the wheel of the vehicle 100 or by a speed sensor in the vehicle 100.

In block 12, the acquiring module 20 acquires the intersection information in front of the real-time position information of the vehicle 100, and the traffic light color-change function.

In at least one embodiment, the intersection information, which indicates the distance of the vehicle 100 to pass through the intersection, includes an intersection distance of the vehicle 100 and a traffic light information. The intersection distance includes a first distance and a second distance. The first distance is from the real-time position to the intersection, and the second distance is a width of the intersection. In at least one embodiment, the first distance and the second distance are obtained through the HD map 2. In another embodiment, one of the first distance and the second distance can be obtained through the HD map 2, and the other of the first distance and the second distance can be obtained through the camera 106. In another embodiment, both the first distance and the second distance are obtained by the camera 106.

The traffic light information includes a color information of the traffic light and a traffic light color-change function. The intersection generally displays three traffic lights as described previously.

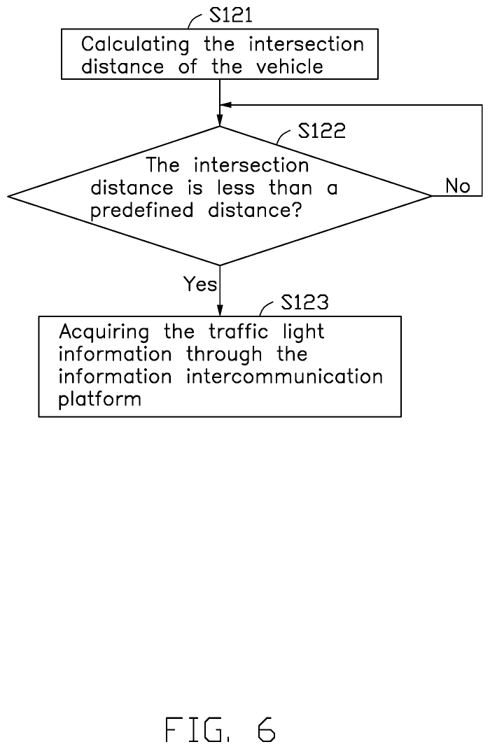

FIG. 6 shows a detailed flowchart of the block 12.

In block 121, the acquiring module 20 further calculates the intersection distance of the vehicle 100.

In block 122, the determining module 30 determines whether the intersection distance is less than a predefined distance.

In block 123, the acquiring module 20 acquires traffic light information through the information intercommunication platform 300 when the intersection distance is less than the predefined distance.

When the intersection distance is greater than the predefined distance, the procedure returns to block 121.

In block 13, the determining module 30 determines whether the vehicle 100 can safely pass through the intersection based on the real-time driving speed of the vehicle 100 and the intersection information.

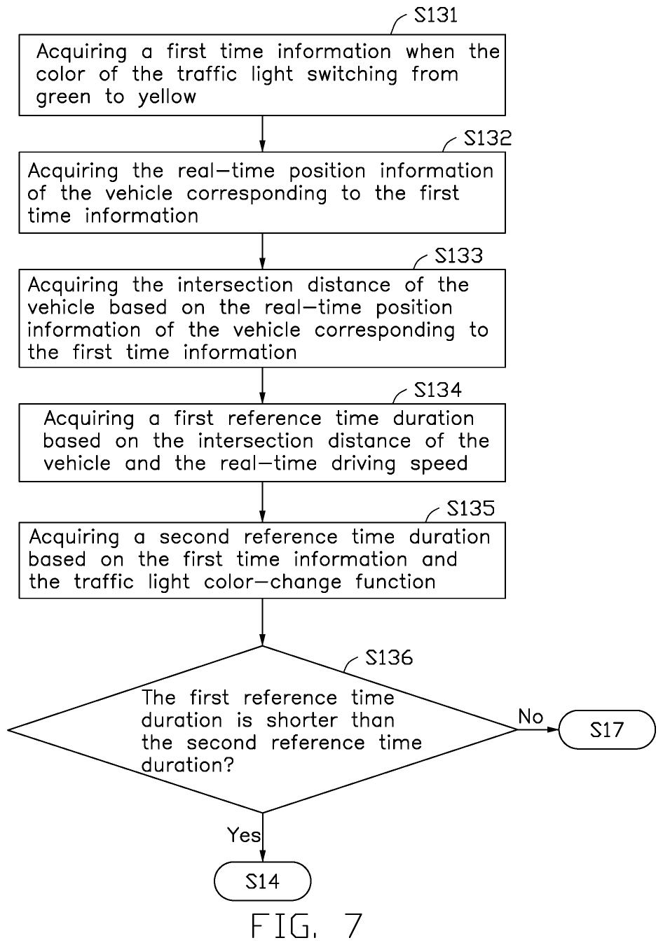

FIG. 7 shows a detailed flowchart of the block 13.

In block 131, the acquiring module 20 further acquires a first time information when the color of the traffic light switches from green to yellow.

In block 132, the acquiring module 20 further acquires the real-time position information of the vehicle 100 corresponding to the first time information.

In block 133, the acquiring module 20 further acquires the intersection distance based on the real-time position information of the vehicle 100 corresponding to the first time information.

In block 134, the acquiring module 20 further acquires a first reference time duration based on the intersection distance of the vehicle 100 and the real-time driving speed.

In block 135, the acquiring module 20 further acquires a second reference time duration based on the first time information and the traffic light color-change function.

In block 136, the determining module 30 further determines whether the first reference time duration is greater than the second reference time duration.

When the first reference time duration is greater than the second reference time duration, the vehicle 100 cannot safely pass through the intersection, the procedure goes to block S17.

When the first reference time duration is shorter than or equal to the second reference time duration, the vehicle 100 can safely pass through the intersection, the procedure goes to block S14.

In at least one embodiment, the second reference time duration is a switching time duration for switching the current color of the corresponding traffic light to next color. For example, when the time of switching the color of the corresponding traffic light switches from green to yellow at 10:23:00, the first time information acquired by the acquiring module 10 is 10:23:00. The real-time position information of the vehicle 100 is acquired by the location module 10 based on the first time information. The intersection distance is acquired from on the HD map 2 based on the real-time position information. The intersection distance includes the first distance and the second distance. The first distance is a distance from the real-time position to the intersection, and the second distance is a width across the intersection. The first reference time duration is 10 seconds based on the intersection distance and the real-time driving speed of the vehicle 100. The second reference time duration of switching the color of the corresponding traffic light from yellow to red is 5 seconds based the traffic light color-change function. The first reference time duration is greater than the second reference time duration, thus it is determined that the vehicle 100 cannot safely pass through the intersection.

In another embodiment, when the color of the corresponding traffic light switches from green to yellow at 12:10:00, the first time information is 12:10:00. The real-time position information of the vehicle 100 is acquired by the location module 10 based on the first time information. The intersection distance is acquired from on the HD map 2 based on the real-time position information. The intersection distance includes the first distance and the second distance. The first distance is a distance from the real-time position information to the intersection, and the second distance is a width across the intersection. The first reference time duration is 3 seconds based on the intersection distance and the real-time driving speed of the vehicle 100. The second reference time duration of switching the color of the corresponding traffic light from yellow to red is 5 seconds based the traffic light color-change function. The first reference time duration is shorter than the second reference time duration, thus it is determined that the vehicle 100 can safely pass through the intersection.

When the vehicle 100 cannot safely pass through the intersection, the procedure goes to block S17.

When the vehicle 100 can safely pass through the intersection, the procedure goes to block S14.

In block 14, the information intercommunication platform 300 receives the results of determination from the vehicles 100 in the predefined region R.

In at least one embodiment, the result of determination includes whether the vehicle 100 can safely pass through the intersection and an expected time of passing through the intersection.

The information intercommunication platform 300 receives the results of determination from several vehicles 100 in the predefined region R based on the real-time position information. In at least one embodiment, as shown in FIG. 4, the predefined range R is a circular region with a center on the center of the intersection, and a diameter of the predefined range R is a predefined value. In other embodiments, the predefined range R can be other shape, such as a rectangular, or a T shape, not being limited hereto.

In block 15, the information intercommunication platform 300 determines whether a crash at the intersection between each two vehicles 100 in the predefined region R is likely based on the results of determination from the vehicles 100.

In at least one embodiment, when the results of determination are the vehicles 100 can safely pass through the same intersection, the processing unit 302 pre-determines whether the expected times are almost the same. In at least one embodiment, the processing unit 302 determines whether a time difference of each two expected times is less than a predefined threshold value (that is, the same or almost the same), for determining whether the expected times are close. When the time difference of two expected times is less than the predefined threshold value, a crash is deemed likely at the intersection between the two vehicles 100 corresponding to the expected times by the processing unit 302, and the warning information is generated. When the time difference of two expected times is larger than or equal to the predefined threshold value (that is, not almost the same), a crash is deemed unlikely at the intersection between the two vehicles 100 corresponding to the expected times by be processing unit 302.

In block 16, the warning information is outputted to the corresponding vehicles 100 by the information intercommunication platform 300 when the crash is deemed likely at the intersection between the two vehicles 100 in the predefined region R.

When no crash is deemed likely at the intersection between the two vehicles 100 in the predefined region R, the procedure goes to block S10.

In block 17, a prompt and/or a control event is/are generated by the prompting module 40 and/or the controlling module 50.

In at least one embodiment, the prompt can be a voice prompt, an image prompt, a loud whistled prompt, not being limited hereto. In at least one embodiment, the control event can be a slow-down instruction, a stop instruction, a whistled instruction, not being limited hereto.

Based on the method for driving assistance based on the HD map 2, the driving characteristics and intersection information are acquired, and whether the vehicle 100 can safely pass through the intersection is determined. A result of determination is transmitted to the information intercommunication platform 300, and the information intercommunication platform 300 determines whether the crash at the intersection between each two vehicles 100 in the predefined region R is likely. If likely, a warning information is generated to the corresponding vehicles 100 when the crash is likely at the intersection. Precise driving assistance is provided, safety while driving the vehicle 100 is improved, and a smart control of the vehicle 100 is optimized.

While various and preferred embodiments have been described the disclosure is not limited thereto. On the contrary, various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. A method of driving assistance based on a HD map used in a vehicle intercommunication system with at least two vehicles and information communication platform, the method comprising:
acquiring driving characteristics, the driving characteristics comprise a real-time position information of the vehicle, a real-time driving speed of the vehicle, and a real-time information;
acquiring intersection information in front of the real-time position information of the vehicle based on the driving characteristics, the intersection information comprising an intersection distance of the vehicle passing through an intersection and a traffic light information;
determining whether the vehicle can safely pass through the intersection based on the real-time driving speed of the vehicle and the intersection information, and prompting and/or controlling the vehicle based on the result of determination;
outputting the result of determination to the information intercommunication platform; the result of determination comprises whether the vehicle can safely pass through the intersection without being crashed with other vehicles and an expected time of passing through the intersection;
determining whether a crash would occur at the intersection between each two vehicles based on the results of determination from the vehicles in a predefined region; and
generating warning information to the corresponding vehicles when the crash is deemed likely at the intersection.

2. The method of claim 1, wherein the predefined range is a circular region with a center of the intersection, and a diameter of the predefined range is a predefined value.

3. The method of claim 1, wherein the information intercommunication platform communicates with infrastructures; the vehicle acquires the traffic light information from the infrastructure by the information intercommunication platform.

4. The method of claim 1, wherein the step of determining whether a crash would occur at the intersection between each two vehicles based on the results of determination from the vehicles in a predefined region comprises:
determining whether a time difference of each two expected times is less than a predefined threshold value when the results of determination are the vehicles can safely pass the same intersection;
confirming a crash is deemed likely at the intersection between the two vehicles corresponding to the expected times when the time difference of two expected times is less than the predefined threshold value; and
confirming a crash is deemed unlikely at the intersection between the two vehicles corresponding to the expected times when the time difference of two expected times is less than the predefined threshold value.

5. The method of claim 1, wherein the step of determining whether the vehicle can safely pass through the intersection based on the real-time driving speed of the vehicle and the intersection information, and prompting and/or controlling the vehicle based on the result of determination comprises:
acquiring a first reference time information when the color of the traffic light switching from green to yellow;
acquiring the real-time position information of the vehicle corresponding to the first time information;
acquiring the intersection distance of the vehicle based on the real-time position information of the vehicle corresponding to the first time information;
acquiring a first reference time duration based on the intersection distance of the vehicle and the real-time driving speed;
acquiring a second reference time duration based on the first time information and the traffic light color-change function;
determining whether the first reference time duration is shorter than the second reference time duration; and
confirming the vehicle to be safely pass through the intersection when the first reference time duration is shorter than or equal to the second reference time duration.

6. The method of claim 1, wherein the vehicle comprises a camera; the camera captures images to acquire color of traffic light in the traffic light information.

7. The method of claim 6, wherein the intersection distance comprises a first distance and a second distance; the first distance is from the real-time position to the intersection, and the second distance is a width of the intersection.

8. The method of claim 7, wherein at least one of the first distance and the second distance is obtained through the HD map.

9. The method of claim 7, wherein both the first distance and the second distance are obtained through the camera.

10. A vehicle intercommunication system comprises:
an information intercommunication platform configure to communicate with at least two vehicles and at least one infrastructure;
a location module configured to acquire driving characteristics, the driving characteristics comprise a real-time position information of a vehicle of the at least two vehicles, a real-time driving speed of the vehicle, and a real-time information;
an acquiring module configured to acquire intersection information in front of the real-time position information of the vehicle based on the driving characteristics, the intersection information comprising an intersection distance of the vehicle passing through an intersection and a traffic light information;
a determining module configured to determine whether the vehicle can safely pass through the intersection without being crashed with other vehicles based on the real-time driving speed of the vehicle and the intersection information;
a prompting module configured to prompt the vehicle when vehicle cannot safely pass through the intersection;
a controlling module configured to control the vehicle based on the result of determination when vehicle cannot safely pass through the intersection; and
a communication module configured to output the result of determination to the information intercommunication platform; the result of determination comprises whether the vehicle can safely pass through the intersection and an expected time of passing through the intersection, wherein
the information intercommunication platform is configured to determining whether a crash would occur at the intersection between each of the two vehicles based on the results of determination from the vehicles in a predefined region; the information intercommunication platform is further configured to generate warning information to the corresponding vehicles when the crash is deemed likely at the intersection.

11. The vehicle intercommunication system of claim 10, wherein the predefined range is a circular region with a center of the intersection, and a diameter of the predefined range is a predefined value.

12. The vehicle intercommunication system of claim 10, wherein the vehicle acquires the traffic light information from the infrastructure by the information intercommunication platform.

13. The vehicle intercommunication system of claim 10, wherein the determining module determines whether a time difference of each two expected times is less than a predefined threshold value when the results of determination are the vehicles can safely pass the same intersection; a crash is deemed likely at the intersection between the two vehicles corresponding to the expected times when the time difference of two expected times is less than the predefined threshold value; a crash is deemed unlikely at the intersection between the two vehicles corresponding to the expected times when the time difference of two expected times is less than the predefined threshold value.

14. The vehicle intercommunication system of claim 10, wherein the acquiring module further acquires a first reference time information when the color of the traffic light switching from green to yellow, acquires the real-time position information of the vehicle corresponding to the first time information, acquires the intersection distance of the vehicle based on the real-time position information of the vehicle corresponding to the first time information, acquires a first reference time duration based on the intersection distance of the vehicle and the real-time driving speed, acquires a second reference time duration based on the first time information and the traffic light color-change function; the determining module further determines whether the first reference time duration is shorter than the second reference time duration; the vehicle can safely pass through the intersection when the first reference time duration is shorter than or equal to the second reference time duration.

15. The vehicle intercommunication system of claim 10, wherein the vehicle comprises a camera; the camera captures images to acquire color of traffic light in the traffic light information.

16. The vehicle intercommunication system of claim 15, wherein the intersection distance comprises a first distance and a second distance; the first distance is from the real-time position to the intersection, and the second distance is a width of the intersection.

17. The vehicle intercommunication system of claim 16, wherein at least one of the first distance and the second distance is obtained through the HD map.

18. The vehicle intercommunication system of claim 16, wherein both the first distance and the second distance are obtained through the camera.
